(19) United States
(12) Patent Application Publication
(10) Pub. No.: US 2026/0155438 A1
(43) Pub. Date: Jun. 4, 2026

(54) POLYMER SOLID ELECTROLYTE LAMINATE AND PREPARATION METHOD THEREOF

(71) Applicant: LG Energy Solution, Ltd., Seoul (KR)

(72) Inventors: Sunghyun Nam, Daejeon (KR); Hyeaeun Han, Daejeon (KR); Dong Kyu Kim, Daejeon (KR)

(21) Appl. No.: 18/685,845

(22) PCT Filed: May 31, 2023
(86) PCT No.: PCT/KR2023/007467

§ 371 Date: Feb. 22, 2024

(30) Foreign Application Priority Data
May 31, 2022 (KR) 10-2022-0067054
May 31, 2023 (KR) 10-2023-0070061

(51) Int. Cl. H01M 10/0565; C08K 5/435; C09D 7/63; C09D 129/04; H01M 10/42

(52) U.S. Cl. CPC H01M 10/0565; C09D 7/63; C09D 129/04; H01M 10/4235; C08K 5/435; C08K 2201/001; H01M 2300/0082; H01M 2300/0094

(57) ABSTRACT

A polymer solid electrolyte laminate and a preparation method thereof are provided. The polymer solid electrolyte laminate includes a protective layer formed on at least one surface of a polymer solid electrolyte, and the protective layer is capable of protecting the polymer solid electrolyte from moisture and outside air such that physical properties of the polymer solid electrolyte are not changed during post-processes for the polymer solid electrolyte and all subsequent processes such as transportation in a continuous process for mass production.

### CROSS-REFERENCE TO RELATED APPLICATIONS

This application is a National Phase entry pursuant to 35 U.S.C. § 371 of International Application No. PCT/KR2023/007467, filed on May 31, 2023, and claims the benefit of priorities based on Korean Patent Application No. 10-2022-0067054 filed on May 31, 2022, and Korean Patent Application No. 10-2023-0070061 filed on May 31, 2023, the disclosures of which are incorporated herein in their entirety.

### FIELD

The present disclosure relates to a polymer solid electrolyte laminate and a method for manufacturing the same.

### BACKGROUND ART

Since a lithium secondary battery using a liquid electrolyte has a structure in which the negative electrode and the positive electrode are partitioned by a separator, if the separator is damaged by deformation or external impact, a short circuit may occur, which may lead to dangers such as overheating or explosion. Therefore, it can be said that the development of a solid electrolyte that can secure safety in the field of the lithium secondary battery is a very important task.

A lithium secondary battery using a solid electrolyte has advantages in that the safety of the battery is increased, and the leakage of the electrolyte solution can be prevented, thereby improving the reliability of the battery and making it easy to manufacture a thin battery. In addition, since lithium metal can be used as a negative electrode, energy density can be improved, and accordingly, it is expected to be applied to high-capacity secondary batteries for electric vehicles, in addition to small secondary batteries, and is in the limelight as a next-generation battery.

Polymer materials with ion conductivity can be used as raw materials for polymer solid electrolytes, among solid electrolytes, and hybrid materials formed by mixing polymer materials and inorganic materials are also proposed. As the inorganic material, an inorganic material such as oxide or sulfide may be used.

Such a conventional polymer solid electrolyte was prepared through a high-temperature drying process after forming a coating film. However, the conventional preparation technology for the polymer solid electrolyte has limitations in that it is difficult to prepare the polymer solid electrolyte with improved ionic conductivity due to the high crystallinity of the crystalline polymer or semi-crystalline polymer. In other words, the higher the crystallization degree of the polymer, the lower the mobility of the polymer chain. Accordingly, it was difficult to improve the ionic conductivity of the polymer solid electrolyte because there was a limitation in the movement of lithium ions inside the polymer solid electrolyte.

For example, conventional polymer solid electrolytes can be prepared by forming a coating film using polyvinyl alcohol (PVA) containing a hydroxyl group, which is a cross-linkable functional group, as a polymer, and then performing a high-temperature drying process. Specifically, after preparing a PVA aqueous solution by dissolving the PVA in water, the PVA aqueous solution is applied on a substrate by solution casting to form a coating film, and dried at room temperature or high temperature to form a polymer solid electrolyte in the form of a PVA film. At this time, the high temperature may mean 80° C. or higher, which is the glass transition temperature (Tg) of PVA. In the drying process, after the moisture evaporates, a hydrogen bond between the cross-linkable functional groups contained in the PVA is formed, and polymer chain folding occurs due to the hydrogen bond, and thus the crystallization degree of the polymer film increases. As the degree of crystallization increases, a polymer film with brittleness is formed. In polymer films with high degree of crystallization and brittleness, as the polymer chain mobility decreases, when there are dissociated ions inside the polymer film, a phenomenon in which the ionic mobility is also remarkably reduced occurs. For this reason, the general PVA film prepared by the high-temperature drying process after forming the coating film as described above exhibits physical properties that are not suitable as polymer solid electrolytes for lithium secondary batteries.

In order to overcome these limitations of conventional polymer solid electrolytes, a technique has been developed to improve the mobility of the polymer chain and improve the ionic conductivity of the polymer solid electrolyte by adding a plasticizer to a crystalline polymer or semi-crystalline polymer. However, when a plasticizer is used, it may be difficult to set process conditions because appropriate dispersibility and solubility (miscibility) between the polymer and the plasticizer must be secured. In addition, when a liquid plasticizer is applied, compatibility with the polymer is reduced, and it may be difficult to perform the preparation process of the polymer solid electrolyte.

Accordingly, there is a demand for technology development that can improve the ionic conductivity of polymer solid electrolytes without additional additives such as plasticizers.

In addition, demands for development of a technology capable of, while going through all processes for preparing a polymer solid electrolyte, preventing changes in the physical properties of the polymer solid electrolyte caused by moisture and outside air are also increasing.

### RELATED ART

Chinese Laid-open Patent Publication No. 112259788

### SUMMARY

It is an object of the present disclosure to provide a polymer solid electrolyte laminate capable of, during a process for preparing a polymer solid electrolyte, preventing changes in the physical properties of the polymer solid electrolyte caused by moisture and outside air.

It is another object of the present disclosure to provide a method for preparing the polymer solid electrolyte laminate.

In order to achieve the above objects, one embodiment of the present disclosure provides a polymer solid electrolyte laminate comprising: a polymer solid electrolyte including a polymer containing a cross-linkable functional group, a lithium salt and a solvent; and a protective layer formed on at least one surface of the polymer solid electrolyte, wherein the polymer solid electrolyte includes a cross-linked structure; and an amorphous polymer chain containing the cross-linkable functional group, and the cross-linked structure includes (a) a cross-linkage between the cross-linkable functional groups; (b) a cross-linkage between the cross-linkable functional group and the solvent; and (c) a bond between the cross-linkable functional group and the lithium salt.

Another embodiment of the present disclosure provides a method for preparing the polymer solid electrolyte laminate, the method including the steps of: (S1) forming a solution for forming a polymer solid electrolyte by adding a lithium salt to a polymer solution including a polymer containing a cross-linkable functional group and a solvent; (S2) forming a coating film by coating the solution for forming a polymer solid electrolyte on a substrate; (S3) forming a polymer solid electrolyte by freezing and thawing the coating film; and (S4) laminating a protective layer on at least one surface of the polymer solid electrolyte.

A polymer solid electrolyte laminate according to the present disclosure includes a protective layer formed on at least one surface of a polymer solid electrolyte, and the protective layer is capable of, in a continuous process of going on to a lamination process with an electrode after preparing the polymer solid electrolyte and processes such as transportation, preventing changes in the physical properties of the polymer solid electrolyte caused by moisture and the outside air.

### DETAILED DESCRIPTION

Hereinafter, the present disclosure will be described in more detail to help the understanding of the present disclosure.

The terms and words used in the present specification and claims should not be construed as limited to ordinary or dictionary terms, and should be construed in a sense and concept consistent with the technical idea of the present disclosure, based on the principle that the inventor can properly define the concept of a term to describe his disclosure in the best way possible.

As used herein, the term “cross-linked structure” refers to a structure comprising a three-dimensional frame formed by polymer chains and an internal space of the frame. The polymer chain may be formed by cross-linkages comprising cross-linkable functional groups contained in the polymer. Since the cross-linked structure has a three-dimensional shape and has a form in which polymer chains are entangled with each other, it can also be referred to as a three-dimensional network structure.

### Polymer Solid Electrolyte Laminate

The present disclosure relates to a polymer solid electrolyte laminate.

The polymer solid electrolyte laminate according to the present disclosure includes a polymer solid electrolyte including a polymer containing a cross-linkable functional group, a lithium salt, and a solvent; and a protective layer formed on at least one surface of the polymer solid electrolyte. In addition, the polymer solid electrolyte includes a cross-linked structure; and an amorphous polymer chain containing the cross-linkable functional group, and the cross-linked structure includes (a) a cross-linkage between cross-linkable functional groups; (b) a cross-linkage between the cross-linkable functional group and the solvent; and (c) a bond between the cross-linkable functional group and the lithium salt. Specifically, the amorphous polymer chain and the lithium salt are included in an inner space formed in the cross-linked structure, and the lithium salt is included in a dissociated state.

In addition, the cross-linked structure may be formed in a freezing process as to be described later. In the freezing process, some of the cross-linkable functional groups included in the polymer form localized crystallites, and the cross-linked structure may be formed by the localized crystallites acting as a cross-linkable junction point and a cross-linkage. In this case, the crystallite means a shape like a knot made by tangled threads, unlike a crystal structure formed by polymer chain folding.

In the present disclosure, the protective layer may be formed on at least one surface of the polymer solid electrolyte to play a role to protect the polymer solid electrolyte from mechanical friction or physical damage during the preparing process of a battery to which the polymer solid electrolyte is applied, and also play a role to prevent a phenomenon in which physical properties of the polymer solid electrolyte are changed due to moisture and outside air.

During the battery manufacturing process, when the polymer solid electrolyte needs to be handled under an environment in which moisture is well blocked, a protective layer capable of protecting the polymer solid electrolyte from simple mechanical friction or damage is sufficient. At this time, the protective layer may have greater mechanical strength compared to the polymer solid electrolyte. The mechanical strength may mean modulus.

The protective layer may be a polymer film having a larger modulus compared to the polymer solid electrolyte, or a low-hygroscopic polymer film.

The polymer film having a larger modulus compared to the polymer solid electrolyte may include a polyester film, a polycarbonate (PC) film, a polyethylene (PE) film, a polymethyl methacrylate (PMMA) film, a polyetheretherketone (PEEK) film, a polyethylene naphthalate (PEN) film, a polyetherimide (PEI) film, a polyimide (PI) film, a triacetylcellulose (TAC) film, or an elongated polyvinyl alcohol (PVA) film, and
the low-hygroscopic polymer film may include a cycloolefin polymer (COP) film, a polyethylene terephthalate (PET) film, a polyacrylate (PAC) film, a polyethylene naphthalate (PEN) film, a polyvinylidene chloride (PVDC) film, a polyvinyl chloride (PVC) film, or an ethylene vinyl alcohol copolymer (EVOH) film.

In addition, the low-hygroscopic polymer film may have excellent moisture barrier properties.

The protective layer is not particularly limited as long as it has properties of moisture barrier and/or low moisture permeability. For example, the protective layer may have a water vapor transmission rate (WVTR) of 50 g/m²·day or less, 40 g/m²·day or less, 30 g/m²·day or less, 20 g/m²·day or less, or 10 g/m²·day or less. When the protective layer has a water vapor transmission rate of 50 g/m²·day or less, an effect of preparing the polymer solid electrolyte under an environment in which moisture is almost blocked is shown. In this case, ionic conductivity is not lost even when exposed to an external environment such as moisture, and the prepared polymer solid electrolyte may exhibit lithium-specific ionic conductivity.

On the other hand, if the protective layer has a water vapor transmission rate exceeds 50 g/m² day, the function of protecting the polymer solid electrolyte from moisture and/or outside air may be reduced, however, due to the influence of the moisture, the polymer solid electrolyte may rather have higher ionic conductivity. The reason why the polymer solid electrolyte has high ionic conductivity when the protective layer has high water vapor transmission rate is that, in addition to ionic conductivity by lithium ions, ionic conductivity by the protons (H⁺) of the absorbed moisture (proton hopping), that is, ionic conductivity by moisture is added thereto.

Generally, in order for ionic conductivity of a polymer solid electrolyte to be directly involved in improving actual battery performance, it is preferable that the ionic conductivity is the ionic conductivity exhibited by lithium ions. If the ionic conductivity of the polymer solid electrolyte is exhibited by moisture, its contribution to improving actual battery performance is insignificant or almost none.

Accordingly, since the high ionic conductivity of the polymer solid electrolyte exhibited when the protective layer included in the polymer solid electrolyte has high water vapor transmission rate is not ionic conductivity obtained only by lithium ions, it may be an ionic conductivity having an insignificant influence on improving actual battery performance. In other words, since the water content increases in a state where the water vapor transmission rate of the protective layer is high, the ionic conductivity is increased by the moisture, which is not ionic conductivity by lithium ions relevant to actual battery performance.

A method for measuring the water vapor transmission rate is not particularly limited as long as it is a method that may be applied for measuring a water vapor transmission rate of an object to be measured having a shape similar to a film in the art. For example, the water vapor transmission rate may be measured using an Aquatron apparatus manufactured by Mocon company. In the apparatus, after fixing a film between two chambers, while introducing moisture into one chamber, nitrogen is flowed into the opposite chamber, thereby measuring the nitrogen concentration in the moisture passing through the film may be measured.

In addition, the protective layer may include one or more selected from the group consisting of a cycloolefin polymer (COP) film, a polyethylene terephthalate (PET) film, a polyacrylate (PAC) film, a polyethylene naphthalate (PEN) film, a polyvinylidene chloride (PVDC) film, a polyvinyl chloride (PVC) film, and an ethylene vinyl alcohol copolymer (EVOH) film. These films may be a polymer film having a non-porous structure.

Generally, in a polymer film having a non-porous structure, permeability of moisture or gas is known to be affected by a chemical structure and/or the degree of crystallinity of the polymer forming the film. In addition, the inside of the polymer is divided into a crystalline region and an amorphous region, and gas permeation mostly occurs in the amorphous region. In the inside of the amorphous region, there exist a lot of free volumes larger than the size of the permeating gas molecules, which enables active movements of the gas molecules, facilitating gas permeation in the polymer film. The gas permeation mechanism in the polymer film may be divided into a process in which the gas molecules are dissolved into the film, and a process in which the gas molecules are diffused into the film.

Accordingly, a gas permeability coefficient (P) of the polymer film may be expressed as a product of a solubility constant (S) and a diffusion coefficient (D) as in the following Equation 1.

$$P = S \cdot D \qquad [ Equation 1 ]$$

In this case, in order for the polymer film to have properties of moisture barrier and/or low moisture permeability, it may be preferred that the solubility constant (S) and/or the diffusion coefficient (D) are low, resulting in a low gas permeability coefficient (P) value, and these physical properties may be affected by functional group types, bonding strength, the degree of crystallinity, polarity, orientation and the like.

Accordingly, the present disclosure may provide a polymer solid electrolyte laminate capable of, by introducing a polymer film having a low water vapor transmission rate (WVTR) as a protective layer of a polymer solid electrolyte, protecting ionic conductivity and mechanical properties of the polymer solid electrolyte.

The polymer solid electrolyte according to the present disclosure includes a polymer containing a cross-linkable functional group and a lithium salt.

In addition, the polymer solid electrolyte has a structure including a cross-linked structure; and an amorphous polymer chain containing the cross-linkable functional group, and the cross-linked structure includes (a) a cross-linkage between the cross-linkable functional groups, (b) a cross-linkage between the cross-linkable functional group and the solvent, and (c) a bond between the cross-linkable functional group and the lithium salt. Specifically, the amorphous polymer chain and the lithium salt are included in an inner space formed in the cross-linked structure, and the lithium salt is included in a dissociated state.

In the present disclosure, (a) the cross-linkage between cross-linkable functional groups may comprise a hydrogen bond between cross-linkable functional groups, and for example, the hydrogen bond may be a hydrogen bond between OH− groups.

If the cross-linked structure is formed only by (a) the cross-linkage between cross-linkable functional groups, crystallinity of the polymer solid electrolyte may be generated, and thus ionic conductivity may be reduced.

However, since the cross-linked structure comprise not only (a) the cross-linkage between cross-linkable functional groups, but also (b) the cross-linkage between the cross-linkable functional group and the solvent, and (c) the bond between the cross-linkable functional group and the lithium salt, the generation of crystallinity of the polymer solid electrolyte can be prevented.

In the present disclosure, (b) the cross-linkage between the cross-linkable functional group and the solvent may comprise a hydrogen bond, for example, the hydrogen bond may be a hydrogen bond between OH− and H+. At this time, H+ may be derived from a water solvent.
(b) the cross-linkage between the cross-linkable functional group and the solvent may mean a hydrogen bond between a part of the solvent remaining in the freezing and thawing processes and the cross-linkable functional group.

In addition, (b) the cross-linkage between the cross-linkable functional group and the solvent interferes with the cross-linkage between (a) the cross-linkable functional groups, so that the cross-linked structure does not consist only of the cross-linkage between (a) the cross-linkable functional groups, and thus the increase in crystallinity of the polymer solid electrolyte can be prevented.

In the present disclosure, (c) the bond between the cross-linkable functional group and the lithium salt may comprise a Lewis acid-base interaction, and for example, the bond may be a bond between OH− and Li+.

(c) the bond between the cross-linkable functional group and the lithium salt is a Lewis acid-base interaction, and may be a type of bond such as a metal-ligand bond.

In addition, (c) the bond between the cross-linkable functional group and the lithium salt interferes with (a) the cross-linkage between cross-linkable functional groups and (b) the cross-linkage between the cross-linkable functional group and the solvent, so that the cross-linked structure does not consist only of the cross-linkage between (a) the cross-linkable functional groups, and thus the generation of crystallinity of the polymer solid electrolyte can be prevented, and at the same time, the formation of amorphous polymer chains can be promoted. As the amorphous polymer chain is formed, the mobility of the polymer chain is improved, and thus the hopping effect of the lithium ion is increased, so that the ionic conductivity of the polymer solid electrolyte can be improved.

In the present disclosure, the amorphous polymer chain may also be formed in a freezing process as described later, and refers to a polymer chain that does not form crystals by regular folding of the polymer chain and exists in a free behavior state. That is, the amorphous polymer chain may include a polymer containing a cross-linkable functional group that does not form bonds as in (a), (b) and (c).

Due to the cross-linked structure, the polymer solid electrolyte is not easily broken or destroyed and thus can play a role as a support for an electrolyte containing lithium ions stably.

In addition, due to the amorphous polymer chain, since the polymer solid electrolyte exhibits elasticity, it can minimize brittleness, which is a property of being easily broken, and since the mobility of the polymer chain is excellent and the mobility of lithium ions inside the electrolyte is improved, the polymer solid electrolyte with improved ionic conductivity can be provided.

In the present disclosure, the cross-linkable functional group contained in the polymer containing the cross-linkable functional group may have a property capable of forming a cross-linked structure by forming bonds as in the (a), (b) and (c).

For example, the cross-linkable functional group may include one or more selected from the group consisting of a hydroxyl group, a carboxyl group, and an amide group.

In addition, the weight average molecular weight (Mw) of the polymer containing the cross-linkable functional group may be 80,000 g/mol to 130,000 g/mol, and specifically, may be 80,000 g/mol or more, 83,000 g/mol or more or 85,000 g/mol or more, and 90,000 g/mol or less, 110,000 g/mol or less or 130,000 g/mol or less. If the weight average molecular weight (Mw) of the polymer containing the cross-linkable functional group is less than 80,000 g/mol, the bond by the cross-linkable functional group may not be formed sufficiently to obtain a cross-linked structure. If the weight average molecular weight (Mw) of the polymer containing the cross-linkable functional group exceeds 130,000 g/mol, the entanglement of the polymer chain is increased in the polymer solution used in the preparation process, and the penetration rate of the solvent into the polymer chain is decreased. Accordingly, gelation of the polymer is accelerated, and thus the solubility of the polymer is lowered and the bonding by the cross-linkable functional group cannot be performed smoothly, so the formation of a cross-linked structure may not be easy.

In addition, the polymer containing the cross-linkable functional group may have characteristic in that the bonds (a), (b) and (c) are well formed by the cross-linkable functional group contained in the phase separated polymer upon freezing because phase separation between the polymer and the solvent is smoothly performed in the polymer solution used in the preparation process.

For example, the polymer containing the cross-linkable functional group may include one or more selected from the group consisting of polyvinyl alcohol (PVA), gelatin, methylcellulose, agar, dextran, poly(vinyl pyrrolidone), poly(ethylene oxide), poly(acryl amide), poly(acrylic acid) (PAA), starch-carboxymethyl cellulose, hyaluronic acid-methylcellulose, chitosan, poly(N-isopropylacrylamide), and amino-terminated polyethylene glycol (amino-terminated PEG). Preferably, the polymer containing the cross-linkable functional group may be PVA, and the PVA can be efficiently phase separated from the solvent upon freezing in the preparation process of the polymer solid electrolyte and it may be advantageous in forming a cross-linked structure by the bonds (a), (b) and (c) induced from the cross-linkable functional group of PVA phase separated from the solvent.

In the present disclosure, the lithium salt is included in a dissociated state in the inner space of the cross-linked structure, thereby improving the ionic conductivity of the polymer solid electrolyte.

In addition, the lithium salt can form (c) the bond between the cross-linkable functional group and the lithium salt, thereby preventing the generation of crystallinity of the polymer solid electrolyte and promoting the formation of an amorphous polymer chain at the same time.

The lithium salt may include one or more selected from the group consisting of (CF₃SO₂)₂NLi (Lithium bis(trifluoromethanesulphonyl)imide, LiTFSI), (FSO₂)₂NLi (Lithium bis(fluorosulfonyl)imide, LiFSI), LiNO₃, LiOH, LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, LiSCN, and LiC(CF₃SO₂)₃.

In the present disclosure, the molar ratio ([Li]/[G]) of lithium ([Li]) of the lithium salt to the cross-linkable functional group ([G]) of the polymer containing the cross-linkable functional group contained in the polymer solid electrolyte may be more than 0.1 and less than 0.5, and specifically may be more than 0.1, 0.2 or more, or 0.3 or more, and may be 0.4 or less, or 0.5 or less. If the molar ratio ([Li]/[G]) is 0.1 or less, as the content of the lithium salt is reduced, the ionic conductivity of the polymer solid electrolyte may be lowered. If the molar ratio ([Li]/[G]) is 0.5 or more, the content of the polymer containing the cross-linkable functional group is reduced, so that the bonds (a), (b) and (c) may not be sufficiently formed and thus crystallinity may be increased and ionic conductivity may be decreased. If the cross-linkable functional group is a hydroxyl group (OH−), the [G] may be expressed as [OH] or [0].

In the present disclosure, the polymer solid electrolyte may be in the form of a free-standing film or a coating layer. The free-standing film refers to a film capable of maintaining a film shape by itself without a separate support at room temperature and pressure. The coating layer means a layer obtained by coating on a substrate. If the polymer solid electrolyte is in the form of a coating layer, the coating layer may be in the form of a layer coated on an electrode.

The free-standing film or coating layer exhibits elasticity to minimize brittleness and has characteristics as a support that stably contains lithium ions, and thus it can be in a suitable form as a polymer solid electrolyte.

In the present disclosure, the polymer solid electrolyte may further include a liquid electrolyte, and by the liquid electrolyte, ionic conductivity of the polymer solid electrolyte may be further improved. The liquid electrolyte may also be included in an inner space of the cross-linked structure.

The liquid electrolyte may be a liquid electrolyte commonly used in the art, and the composition of the liquid electrolyte is not particularly limited as long as it is usable in a lithium secondary battery. For example, the liquid electrolyte may include a lithium salt and a non-aqueous solvent. The lithium salt may be one of the lithium salts described above. In addition, the non-aqueous solvent may include one or more selected from the group consisting of propylene carbonate (PC), ethylene carbonate (EC), vinylene carbonate (VC), diethyl carbonate (DEC) dimethyl carbonate (DMC), methylethyl carbonate (MEC), ethylmethyl carbonate (EMC), tetrahydrofuran (THF), 2-methyltetrahydrofuran (2MeTHF), dioxolane (DOX), dimethoxyethane (DME), diethoxyethane (DEE), γ-butyrolactone (GBL), acetonitrile (AN) and sulfolane.

In addition, the liquid electrolyte may be included in an amount of 1% by weight to 5% by weight based on the total weight of the polymer solid electrolyte. When the liquid electrolyte content is 1% by weight or less, the effect of improving ionic conductivity may be insignificant, and when the content exceeds 5% by weight, stability may be reduced.

The polymer solid electrolyte as described above may be prepared in a form including a cross-linked structure formed by the bonds such as the (a), (b) and (c) formed by the cross-linkable functional group contained in the polymer and an amorphous polymer chain including a polymer having a cross-linkable functional group with no cross-linkage. Due to such morphological properties, the polymer solid electrolyte is capable of performing a role of a support stably containing lithium ions, minimizing brittleness by exhibiting elasticity, and improving ionic conductivity by preventing crystallinity from occurring.

### Method for Preparing Polymer Solid Electrolyte Laminate

The present disclosure also relates to a method for preparing a polymer solid electrolyte laminate, and the method includes the steps of: (S1) forming a solution for forming a polymer solid electrolyte by adding a lithium salt to a polymer solution including a cross-linkable functional group; (S2) forming a coating film by applying the solution for forming the polymer solid electrolyte on a substrate; (S3) forming the polymer solid electrolyte by freezing and thawing the coating film; and (S4) laminating a protective layer on at least one surface of the polymer solid electrolyte.

In the method for preparing the polymer solid electrolyte laminate, a laminate capable of protecting the polymer solid electrolyte from physical contact, or moisture and outside air may be prepared using a simple method of laminating a protective layer on at least one surface of the polymer solid electrolyte.

In addition, in the process for preparing the polymer solid electrolyte, (a) a cross-linkage between the cross-linkable functional groups, (b) a cross-linkage between the cross-linkable functional group and the solvent, and (c) a bond between the cross-linkable functional group and the lithium salt by the cross-linkable functional group contained in the polymer are induced through a freezing process, without adding a plasticizer used for reducing polymer crystallinity, thereby preventing the crystallization of the polymer, and as a result, the polymer solid electrolyte with improved ionic conductivity may be prepared.

Hereinafter, the method for preparing a polymer solid electrolyte according to the present disclosure will be described in more detail for each step.

In the present disclosure, in the step (S1), a solution for forming a polymer solid electrolyte can be prepared by adding a lithium salt to a polymer solution containing the cross-linkable functional group. The types and physical properties of the polymer containing the cross-linkable functional group and the lithium salt are as described above.

The solvent used when preparing the polymer solution may be a polar solvent, and for example, may be water. In other words, the polymer solution may be an aqueous polymer solution.

The concentration of the polymer solution including the cross-linkable functional group can be appropriately adjusted considering the extent to which the coating process can proceed smoothly, when the solution for forming the polymer solid electrolyte is applied to the substrate. For example, the concentration of the polymer solution containing the cross-linkable functional group may be 5% to 20%, and specifically may be 5% or more, 7% or more or 9% or more, and may be 13% or less, 17% or less or 20% or less. If the concentration of the polymer solution containing the cross-linkable functional group is less than 5%, the concentration is too dilute and thus it may flow down when applied on the substrate. If the concentration of the polymer solution containing the cross-linkable functional group exceeds 20%, it is difficult to dissolve the lithium salt at a desired concentration in the solution of the polymer, and it may be difficult to apply it in the form of a uniform thin film due to its high viscosity.

In the present disclosure, in the step (S2), a coating film may be formed by applying the solution for forming the polymer solid electrolyte on the substrate.

The substrate is not particularly limited as long as it can serve as a support on which the solution for forming the polymer solid electrolyte is applied. For example, the substrate may be stainless steel (SS), a polyethylene terephthalate film, a polytetrafluoroethylene film, a polyethylene film, a polypropylene film, a polybutene film, a polybutadiene film, a vinyl chloride copolymer film, a polyurethane film, an ethylene-vinyl acetate film, an ethylene-propylene copolymer film, an ethylene-ethyl acrylate copolymer film, an ethylene-methyl acrylate copolymer film, or a polyimide film.

In addition, the coating method is not particularly limited as long as it is a method capable of applying the solution for forming the polymer solid electrolyte in the form of a film on the substrate. For example, the coating method may be bar coating, roll coating, spin coating, slit coating, die coating, blade coating, comma coating, slot die coating, lip coating, or solution casting.

In the present disclosure, in the step (S3), the coating film may be frozen and thawed to form a cross-linked structure. In other words, in the freezing process, the bonds of (a), (b) and (c) are induced by the cross-linkable functional group to form a cross-linked structure, and an amorphous polymer chain may be formed.

In the freezing process, the polymer and water included in the aqueous polymer solution containing the cross-linkable functional group used for forming the coating film may be phase separated. The phase separation may be induced because the strength of the hydrogen bond between the water molecules is stronger than that between the cross-linkable functional group and the water molecules. Water molecules aggregated by hydrogen bonds between the water molecules exist in the ice phase by a freezing process. As a result, the number of cross-linkable functional groups forming hydrogen bonds through interaction with the water molecules is significantly reduced.

In other words, in the freezing process of the coating film, the polymer and water included in the aqueous polymer solution need to be phase separated first, and the phase separation may be induced by the hydrogen bond between the water molecules.

Due to the phase separation, the inside of the coating film is divided into (i) a polymer-poor phase and (ii) a polymer-rich phase.

The (i) polymer-poor phase is a portion containing water molecules aggregated by hydrogen bonds between water molecules and exists as an ice phase, which can also be referred to as a free water state.

The (ii) polymer-rich phase is a portion containing a polymer phase separated from water. The phase-separated polymer is a polymer containing a cross-linkable functional group that is free from interaction with water molecules, and is in a free state after phase separation, does not form crystals by regular folding, and exists in an amorphous state with relatively free behavior, which is called an amorphous polymer chain.

In addition, some of the cross-linkable functional groups contained in the phase separated polymer form localized crystallites. The localized crystallites act as a cross-linkable junction point to form a cross-linked structure including the bonds (a), (b) and (c).

In addition, in the thawing process after the freezing process, the ice contained in the (i) polymer-poor phase melts and evaporates, and thus a polymer solid electrolyte with an increased free volume can be prepared.

In addition, the freezing may be performed by appropriately selecting conditions sufficient to freeze the coating film. For example, the freezing may be performed at a temperature of −30° C. to −10° C., and specifically, the freezing temperature may be −30° C. or higher, −25° C. or higher, or −23° C. or higher, and may be −18° C. or lower, −15° C. or lower or −10° C. or lower. If the freezing temperature is less than −30° C., cracks may occur in the coating film. If the freezing temperature exceeds −10° C., formation of amorphous polymer chain region can be difficult because sufficient phase separation between the polymer and water is not achieved. In addition, the freezing may be performed considering a sufficient freezing time within the range of 20 hours to 30 hours.

In addition, the thawing can be performed by appropriately selecting conditions capable of thawing to the extent that the frozen coating film can be applied as a polymer solid electrolyte. For example, the thawing temperature may be 15° C. to 35° C. or may be room temperature (25° C.). If the thawing temperature is less than 15° C., moisture drying efficiency may decrease after thawing (ice melting). If the thawing temperature exceeds 35° C., the coating film may shrink and thus cause wrinkles or warping.

In addition, in the process of preparation method of the polymer solid electrolyte, the bonds of (a), (b) and (c) are induced without adding a plasticizer used to reduce crystallinity of the polymer, thereby preventing crystallization of the polymer, and as a result, a polymer solid electrolyte with improved ionic conductivity may be prepared.

After the step (S3), a process of loading the polymer solid electrolyte into a liquid electrolyte and then drying the result may be further included. The composition and the content of the liquid electrolyte are the same as described above.

In the present disclosure, in the step (S4), a protective layer may be laminated on at least one surface of the polymer solid electrolyte to obtain a polymer solid electrolyte laminate. The type of the protective layer is the same as described above.

After preparing the polymer solid electrolyte, a process of laminating the polymer solid electrolyte and an electrode is performed as a continuous process. At this time, the continuous process is a continuous process in which the process for preparing the polymer solid electrolyte and the process for laminating the polymer solid electrolyte and an electrode are connected and performed as one line, or a continuous process in which the polymer solid electrolyte prepared by the roll to roll process is wound and temporarily stored, and later, is unwound again and introduced to a lamination process with an electrode.

In the continuous process as above and all process such as transportation, the protective layer may be formed to prevent changes in the physical properties of the polymer solid electrolyte caused by moisture and outside air.

The protective layer may be laminated on at least one surface of the polymer solid electrolyte through a roll-to-roll lamination, and since the polymer solid electrolyte itself has some sticky properties, the protective layer may be attached thereto by adhesive strength of the polymer solid electrolyte itself.

### All-Solid-State Battery

The present disclosure also relates to an all-solid-state battery including the polymer solid electrolyte, wherein the all-solid-state battery includes an negative electrode, a positive electrode, and a polymer solid electrolyte provided between the negative electrode and the positive electrode, and the solid electrolyte has the properties described above.

Specifically, the polymer solid electrolyte may be suitable as an electrolyte for an all-solid-state battery because physical cross-linkage is formed through the freezing and thawing processes and thus crystallinity is lowered, and ionic conductivity is improved accordingly.

In addition, the protective layer is removed when the polymer solid electrolyte laminate is applied to a battery, and therefore, the protective layer is not included in the all-solid-state battery.

In the present disclosure, the positive electrode contained in the all-solid-state battery includes a positive electrode active material layer, and the positive electrode active material layer may be formed on one surface of the positive electrode current collector.

The positive electrode active material layer includes a positive electrode active material, a binder, and a conductive material.

In addition, the positive electrode active material is not particularly limited as long as it is a material capable of reversibly intercalating and de-intercalating lithium ions, and for example, may be, but is not limited to, layered compounds or compounds substituted with one or more transition metals, such as lithium cobalt oxide (LiCoO₂), lithium nickel oxide (LiNiO₂), Li[NiₓCo_{y}Mn_{z}Mᵥ]O₂(wherein, M is any one or two or more elements selected from the group consisting of Al, Ga and In; 0.3≤x<1.0, 0≤y, z≤0.5, 0≤v≤0.1, x+y+z+v=1), Li(LiₐM_{b-a-b′}M′b′) O_{2-c}A_{c} (wherein, 0≤a≤0.2, 0.6≤b≤1, 0≤b′≤0.2, 0≤c≤0.2; M comprises Mn and one or more selected from the group consisting of Ni, Co, Fe, Cr, V, Cu, Zn and Ti; M′ is one or more selected from the group consisting of Al, Mg and B, and A is one or more selected from the group consisting of P, F, S and N); lithium manganese oxide such as Formula Li_{1+y}Mn_{2-y}O₄ (wherein, y is 0-0.33), LiMnO₃, LiMn₂O₃, LiMnO₂; lithium copper oxide (Li₂CuO₂); vanadium oxide such as LiV₃O₈, LiFe₃O₄, V₂O₅, Cu₂V₂O₇; Ni site type lithium nickel oxide represented by Formula LiNi_{1-y}MyO₂ (wherein, M=Co, Mn, Al, Cu, Fe, Mg, B or Ga, y=0.01-0.3); lithium manganese composite oxide represented by Formula LiMn_{2-y}M_{y}O₂ (wherein, M=Co, Ni, Fe, Cr, Zn or Ta, y=0.01-0.1) or Li₂Mn₃MO₈ (wherein, M=Fe, Co, Ni, Cu or Zn); LiMn₂O₄ in which part of Li in the Formula is substituted with alkaline earth metal ions; disulfide compounds; and Fe₂(MoO₄)₃.

In addition, the positive electrode active material may be contained in an amount of 40 to 80% by weight based on the total weight of the positive electrode active material layer. Specifically, the content of the positive electrode active material may be 40% by weight or more or 50% by weight or more, and may be 70% by weight or less or 80% by weight or less. If the content of the positive electrode active material is less than 40% by weight, the connectivity between the wet positive electrode active material layer and the dry positive electrode active material layer may be insufficient. If the content of the positive electrode active material exceeds 80% by weight, mass transfer resistance may be increased.

In addition, the binder is a component that assists bonding between the positive electrode active material and the conductive material, and assists in bonding to the current collector. The binder may comprise one or more selected from the group consisting of styrene-butadiene rubber, acrylated styrene-butadiene rubber, acrylonitrile copolymer, acrylonitrile-butadiene rubber, nitrile butadiene rubber, acrylonitrile-styrene-butadiene copolymer, acrylic rubber, butyl rubber, fluorine rubber, polytetrafluoroethylene, polyethylene, polypropylene, ethylene/propylene copolymer, polybutadiene, polyethylene oxide, chlorosulfonated polyethylene, polyvinylpyrrolidone, polyvinylpyridine, polyvinyl alcohol, polyvinyl acetate, polyepichlorohydrin, polyphosphazene, polyacrylonitrile, polystyrene, latex, acrylic resin, phenolic resin, epoxy resin, carboxymethylcellulose, hydroxypropyl cellulose, cellulose acetate, cellulose acetate butyrate, cellulose acetate propionate, cyanoethyl cellulose, cyanoethyl sucrose, polyester, polyamide, polyether, polyimide, polycarboxylate, polycarboxylic acid, polyacrylic acid, polyacrylate, lithium polyacrylate, polymethacrylic acid, polymethacrylate, polyacrylamide, polyurethane, polyvinylidene fluoride, and poly(vinylidene fluoride)-hexafluoropropene. Preferably, the binder may comprise one or more selected from the group consisting of styrene-butadiene rubber, polytetrafluoroethylene, carboxymethyl cellulose, polyacrylic acid, lithium polyacrylate, and polyvinylidene fluoride.

In addition, the binder may be contained in an amount of 1% by weight to 30% by weight based on the total weight of the positive electrode active material layer, and specifically, the content of the binder may be 1% by weight or more or 3% by weight or more, and may be 15% by weight or less or 30% by weight or less. If the content of the binder is less than 1% by weight, the adhesive force between the positive electrode active material and the positive electrode current collector may be lowered. If the content of the binder exceeds 30% by weight, the adhesive force is improved, but the content of the positive electrode active material is reduced by that amount, and thus the capacity of the battery may be lowered.

In addition, the conductive material is not particularly limited as long as it prevents side reactions in the internal environment of the all-solid-state battery and has excellent electrical conductivity without causing chemical changes in the battery. The conductive material may be typically graphite or conductive carbon, and for example, graphite such as natural graphite, artificial graphite; carbon black such as carbon black, acetylene black, Ketjen black, Denka black, thermal black, channel black, furnace black, lamp black, thermal black; carbon-based materials whose crystal structure is graphene or graphite; conductive fibers such as carbon fibers and metal fibers; carbon fluoride; metal powders such as aluminum powder and nickel powder; conductive whiskers such as zinc oxide and potassium titanate; conductive oxides such as titanium oxide; and conductive polymers such as polyphenylene derivatives may be used alone or in combination of two or more thereof as the conductive material, but is not necessarily limited thereto.

The conductive material may be generally contained in an amount of 0.5% by weight to 30% by weight based on the total weight of the positive electrode active material layer, and specifically, the content of the conductive material may be 0.5% by weight or more or 1% by weight or more, and may be 20% by weight or less or 30% by weight or less. If the content of the conductive material is too small, i.e., less than 0.5% by weight, it is difficult to expect an effect of improving electrical conductivity or the electrochemical properties of the battery may be deteriorated. If the content of the conductive material exceeds 30% by weight and thus is too large, the amount of the positive electrode active material may be relatively small, so that the capacity and energy density may be lowered. A method for incorporating the conductive material to the positive electrode is not particularly limited, and a conventional method known in the art, such as coating on the positive electrode active material, may be used.

In addition, the positive electrode current collector supports the positive electrode active material layer, and serves to transfer electrons between the external conductive wire and the positive electrode active material layer.

The positive electrode current collector is not particularly limited as long as it has high electrical conductivity without causing chemical changes in the all-solid-state battery. For example, as the positive electrode current collector, copper, stainless steel, aluminum, nickel, titanium, palladium, sintered carbon; a copper or stainless steel surface-treated with carbon, nickel, silver, etc.; an aluminum-cadmium alloy, etc. may be used.

The positive electrode current collector may have a fine irregularity structure on the surface of the positive electrode current collector or have a three-dimensional porous structure, in order to strengthen the bonding force with the positive electrode active material layer. Accordingly, the positive electrode current collector may include various forms such as a film, a sheet, a foil, a mesh, a net, a porous body, a foam, and a non-woven fabric.

The positive electrode as described above may be prepared by the conventional method, and specifically, the positive electrode is manufactured by coating and drying a composition for forming the positive electrode active material layer prepared by mixing the positive electrode active material, the conductive material and the binder in an organic solvent, onto the positive electrode current collector, and optionally compression-molding it onto the current collector to improve the electrode density. At this time, as the organic solvent, it is preferable to use one that can uniformly disperse the positive electrode active material, the binder, and the conductive material and that evaporates easily. Specifically, acetonitrile, methanol, ethanol, tetrahydrofuran, water, isopropyl alcohol and the like are exemplified.

In the present disclosure, the negative electrode comprised in the all-solid-state battery comprises an negative electrode active material layer, and the negative electrode active material layer may be formed on one surface of the negative electrode current collector.

The negative electrode active material may be a material capable of reversibly intercalating or de-intercalating lithium ion (Li⁺), a material capable of reacting with lithium ion to reversibly form a lithium-containing compound, lithium metal or a lithium alloy.

The material capable of reversibly intercalating or de-intercalating lithium ion (Li⁺) may be, for example, crystalline carbon, amorphous carbon or mixtures thereof. The material capable of reacting with the lithium ion (Li⁺) to reversibly form a lithium-containing compound may be, for example, tin oxide, titanium nitrate, or silicon. The lithium alloy may be, for example, an alloy of lithium (Li) and the metal selected from the group consisting of sodium (Na), potassium (K), rubidium (Rb), cesium (Cs), francium (Fr), beryllium (Be), magnesium (Mg), calcium (Ca), strontium (Sr), barium (Ba), radium (Ra), aluminum (Al), and tin (Sn).

Preferably, the negative electrode active material may be lithium metal, and specifically, may be in the form of a lithium metal thin film or lithium metal powder.

The negative electrode active material may be contained in an amount of 40 to 80% by weight based on the total weight of the negative electrode active material layer. Specifically, the content of the negative electrode active material may be 40% by weight or more or 50% by weight or more, and may be 70% by weight or less or 80% by weight or less. If the content of the negative electrode active material is less than 40% by weight, the connectivity between the wet negative electrode active material layer and the dry negative electrode active material layer may be insufficient. If the content of the negative electrode active material exceeds 80% by weight, mass transfer resistance may be increased.

In addition, the binder is the same as described above for the positive electrode active material layer.

In addition, the conductive material is the same as described above for the positive electrode active material layer.

In addition, the negative electrode current collector is not particularly limited as long as it has conductivity without causing chemical change in the battery, and for example, the negative electrode current collector may be copper, stainless steel, aluminum, nickel, titanium, sintered carbon; copper or stainless steel surface-treated with carbon, nickel, titanium, silver, etc.; or aluminum-cadmium alloy. In addition, the negative electrode current collector may be used in various forms, such as a film having fine irregularity on its surface, a sheet, a foil, a net, a porous body, a foam, and a non-woven fabric, as in the positive electrode current collector.

The manufacturing method of the negative electrode is not particularly limited, and may be manufactured by forming an negative electrode active material layer on an negative electrode current collector using a layer or film formation method commonly used in the art. For example, a method such as pressing, coating, or vapor deposition may be used. Also, a case where a thin film of a metal lithium is formed on a metal plate by initial charging after assembling the battery without a lithium thin film on the negative electrode current collector is also included in the negative electrode of the present disclosure.

In addition, the present disclosure provides a battery module comprising the all-solid-state battery as a unit cell, a battery pack comprising the battery module, and a device comprising the battery pack as a power source.

In this case, examples of the above device may comprise, but are not limited to, a power tool powered by an electric motor; electric cars including an electric vehicle (EV), a hybrid electric vehicle (HEV), a plug-in hybrid electric vehicle (PHEV), and the like; electric motorcycles including an electric bike (E-bike) and an electric scooter (E-scooter); an electric golf cart; and a power storage system. Hereinafter, preferred examples are presented to aid understanding of the present disclosure, but the following examples are only illustrative of the present disclosure, and it will be apparent to those skilled in the art that various changes and modifications can be made within the scope and technical idea of the present disclosure, and also it is natural that such variations and modifications are within the scope of the appended claims.

In the following Examples and comparative examples, polymer solid electrolytes were prepared depending on the protective layer and the use of freezing/thawing processes, as described in the following Table 1.

TABLE 1

| | Protective Layer | | Use of Freezing/ |
|---|---|---|---|
| | Film Type | WVTR (g/m² · day) | Thawing Processes |
| Example 1 | COP | 0.5 | Used |
| Example 2 | PET | 15 | Used |
| Example 3 | PAC | 50 | Used |
| Example 4 | TAC | 300 | Used |
| Comparative | — | — | Used |
| Example 1 | | | |
| Comparative | COP | 0.5 | Not Used |
| Example 2 | | | (Simple Drying) |

### Example 1

PVA (Mw: 89,000 g/mol; degree of hydrolysis: >99%) was mixed with water to prepare a 10% aqueous PVA solution. To the aqueous PVA solution, LiTFSI was added, and then stirred to prepare a solution including PVA, which is a polymer having a cross-linkable functional group, and LiTFSI, which is a lithium salt. At this time, a molar ratio ([Li]/[OH]) of “OH”, which is the cross-linkable functional group of the PVA, and “Li” of the lithium salt was set to 0.4.

The solution was applied on SS foil, which is a substrate, by a bar coating method to form a coating film, and then, it was frozen at −20° C. for 24 hours and thawed at 25° C. to prepare a polymer solid electrolyte.

On one surface of the polymer solid electrolyte, a cycloolefin polymer (COP) film (Zeon Film, Japan/JEONOR (50 μm)) was laminated as a protective layer to prepare a polymer solid electrolyte laminate. The COP film had a WVTR of 0.5 g/m²·day.

### Example 2

A polymer solid electrolyte laminate was prepared in the same manner as in Example 1, except that a polyethylene terephthalate (PET) film (50 μm, Toyobo, Japan/T-PET) was used as the protective layer. The PET film had a WVTR of 15 g/m²·day.

### Example 3

A polymer solid electrolyte laminate was prepared in the same manner as in Example 1, except that a polyacrylate (PAC) film (50 μm, LG Chem, Korea/JEONOR (50 μm)) was used as the protective layer. The PAC film had a WVTR of 50 g/m²·day.

### Example 4

A polymer solid electrolyte laminate was prepared in the same manner as in Example 1, except that a triacetyl cellulose (TAC) film (LG Chem, Korea/JEONOR (50 μm)) was used as the protective layer. The TAC film had a WVTR of 300 g/m²·day.

### Comparative Example 1

A polymer solid electrolyte that is not a laminate was prepared in the same manner as in Example 1, except that the protective layer was not laminated.

### Comparative Example 2

A polymer solid electrolyte laminate was prepared in the same manner as in Example 1, except that a solution including PVA, which is a polymer having a cross-linkable functional group, and LiTFSI, which is a lithium salt, was coated on SS foil, which is a substrate, and then dried at 80° C.

Experimental Example 1 The polymer solid electrolyte laminates prepared in the Examples and the Comparative Examples were stored for 72 hours under an environment exposed to moisture, and after removing the protective layer, the mechanical strength, the ionic conductivity, and the amount of change in ionic conductivity (Δσᵢ) caused by moisture of the polymer solid electrolyte were measured as follows. The measurement results are as described in the following Table 2.

### (1) Mechanical Strength

Mechanical strength of the polymer solid electrolyte is modulus measured by a dynamic mechanical analysis (DMA) (TA Instrument, RSA3).

### (2) Ionic Conductivity

In order to measure the ionic conductivity, the polymer solid electrolyte was punched out in a circular shape with a size of 1.7671 cm², and the punched polymer solid electrolyte was placed between two sheets of stainless steel (SS) to prepare a coin cell.

Using an electrochemical impedance spectrometer (EIS, VM3, Bio Logic Science Instrument), the resistance was measured under conditions of an amplitude of 10 mV and a scan range of 500 KHz to 20 MHz at 25° C., and then, using Equation 2 below, the ionic conductivity of the polymer solid electrolyte was calculated.

$${σ}_{i} = \frac{L}{RA} \qquad [ Equation 2 ]$$

In Equation 2 above, σᵢ is the ionic conductivity (S/cm) of the polymer solid electrolyte, R is the resistance (Q) of the polymer solid electrolyte measured by the electrochemical impedance spectrometer, L is the thickness (μm) of the polymer solid electrolyte, and A means the area (cm²) of the polymer solid electrolyte.

At this time, the ionic conductivity is a value obtained by adding the ionic conductivity by lithium ions and the ionic conductivity by moisture.

### (3) Change Amount of Ionic Conductivity Caused by Moisture (Δσₓ, %)

The protective layer formed on the polymer solid electrolyte of Example 1 had a WVTR of 0.5 g/m²·day, and the polymer solid electrolyte of Example 1 represents an ionic conductivity level of a polymer solid electrolyte manufactured under an environment in which moisture is completely blocked. In other words, the ionic conductivity of the polymer solid electrolyte of Example 1 is the same as the ionic conductivity by lithium ions, and the ionic conductivity caused by moisture may be substantially 0.

As shown in Equation 3 below, the change amount of the ionic conductivity caused by moisture (Δσₓ) in the ionic conductivity of the polymer solid electrolytes of Examples 2 to 4 and Comparative Example 1 was calculated as a percentage based on the ionic conductivity of the polymer solid electrolyte of Example 1.

$${Δσ}_{x} = \{ ( {σ}_{x} - {σ}_{Example 1} ) / {σ}_{Exa mple 1} \} \times 100 \qquad [ Equation 3 ]$$

wherein, x is Example 2, 3, 4, or Comparative Example 1. For example, Δσ_{Example 2} is the change amount of the ionic conductivity caused by moisture in Example 2 compared to Example 1.

TABLE 2

| | | | Change Amount | | | |
|---|---|---|---|---|---|---|
| | | | in Ionic | | | |
| | | | Conductivity | | | |
| | Mechanical | Ionic | Caused by | | WVTR | |
| | Strength | Conductivity | Moisture | Protective | (g/m² · | |
| | (kPa) | (S/cm) | (Δσx, %) | Film | day) | Remarks |
| Example 1 | 0.07 | 1.6 × 10⁻⁴ | 0 | COP | 0.5 | — |
| Example 2 | 0.06 | 1.7 × 10⁻⁴ | 6.3 | PET | 15 | — |
| Example 3 | 0.05 | 2.5 × 10⁻⁴ | 56.3 | PAC | 50 | — |
| Example 4 | 0.02 | 4.1 × 10⁻⁴ | 156.3 | TAC | 300 | — |
| Comparative | 0.007 | 6.5 × 10⁻⁴ | 306.3 | — | — | — |
| Example 1 | | | | | | |
| Comparative | — | — | — | — | — | Unable to |
| Example 2 | | | | | | measure: |
| | | | | | | unable to |
| | | | | | | prepare |
| | | | | | | uniform sample |
| | | | | | | on substrate, |
| | | | | | | unable to peel |
| | | | | | | off sample on |
| | | | | | | substrate due |
| | | | | | | to sticky and |
| | | | | | | brittle sample |
| | | | | | | physical |
| | | | | | | properties |

As described in Table 2 above, it was confirmed that the polymer solid electrolyte with no protective layer as in Comparative Example 1 exhibits mechanical strength (modulus) decreased to about 1/10 and ionic conductivity increased by about 4 times, compared to Example 1 due to moisture absorption when exposed to a moisture environment. However, the ionic conductivity is a result of adding the ionic conductivity by moisture rather than the ionic conductivity of lithium ions relevant to battery performance, and therefore, it is not the ionic conductivity advantageous for physical properties of the polymer solid electrolyte relevant to actual battery performance.

In addition, when performing a simple drying process other than the freezing and thawing processes as in Comparative Example 2, a uniform polymer solid electrolyte sample could not be formed on the substrate. In addition, due to sticky and brittle physical properties of the sample, it was impossible to peel off the sample from the substrate, and thus physical properties also could not be measured.

In the above, although the present disclosure has been described by way of limited embodiments and drawings, the present disclosure is not limited thereto, and it is apparent to those skilled in the art that various modifications and variations can be made within the equivalent scope of the technical spirit of the present disclosure and the claims to be described below.

1. A polymer solid electrolyte laminate; comprising:
a polymer solid electrolyte; and
a protective layer formed on at least one surface of the polymer solid electrolyte,
wherein the polymer solid electrolyte comprises a polymer containing a cross-linkable functional group; a lithium salt; and a solvent,
wherein the polymer solid electrolyte comprises a cross-linked structure; and an amorphous polymer chain containing the cross-linkable functional group, and
wherein the cross-linked structure comprises (a) a cross-linkage between the cross-linkable functional groups; (b) a cross-linkage between the cross-linkable functional group and the solvent; and (c) a bond between the cross-linkable functional group and the lithium salt.

2. The polymer solid electrolyte laminate according to claim 1, wherein the protective layer is a polymer film having a larger modulus compared to the polymer solid electrolyte, or a low-hygroscopic polymer film,
the polymer film having a larger modulus compared to the polymer solid electrolyte comprises a polyester film, a polycarbonate (PC) film, a polyethylene (PE) film, a polymethyl methacrylate (PMMA) film, a polyetheretherketone (PEEK) film, a polyethylene naphthalate (PEN) film, a polyetherimide (PEI) film, a polyimide (PI) film, a triacetylcellulose (TAC) film, or an elongated polyvinyl alcohol (PVA) film, and
the low-hygroscopic polymer film comprises a cycloolefin polymer (COP) film, a polyethylene terephthalate (PET) film, a polyacrylate (PAC) film, a polyethylene naphthalate (PEN) film, a polyvinylidene chloride (PVDC) film, a polyvinyl chloride (PVC) film, or an ethylene vinyl alcohol copolymer (EVOH) film.

3. The polymer solid electrolyte laminate according to claim 1, wherein the protective layer has a water vapor transmission rate (WVTR) of 50 g/m²·day or less.

4. The polymer solid electrolyte laminate according to claim 1, wherein (a) the cross-linkage between the cross-linkable functional groups comprises a hydrogen bond,
(b) the cross-linkage between the cross-linkable functional group and the solvent comprises a hydrogen bond, and
(c) the bond between the cross-linkable functional group and the lithium salt comprises a Lewis acid-base interaction.

5. The polymer solid electrolyte laminate according to claim 1, wherein the cross-linkable functional group comprises one or more selected from the group consisting of a hydroxyl group, a carboxyl group, and an amide group.

6. The polymer solid electrolyte laminate according to claim 1, wherein the polymer containing a cross-linkable functional group comprises one or more selected from the group consisting of polyvinyl alcohol (PVA), gelatin, methyl cellulose, agar, dextran, poly(vinyl pyrrolidone), poly(ethylene oxide), poly(acrylamide), poly(acrylic acid) (PAA), starch-carboxymethyl cellulose, hyaluronic acid-methyl cellulose, chitosan, poly(N-isopropylacrylamide), and amino-terminated polyethylene glycol (amino-terminated PEG).

7. The polymer solid electrolyte laminate according to claim 1, wherein the polymer containing the cross-linkable functional group has a weight average molecular weight (Mw) of 80,000 g/mol to 130,000 g/mol.

8. The polymer solid electrolyte laminate according to claim 1, wherein the polymer containing the cross-linkable functional group comprises polyvinyl alcohol (PVA).

9. The polymer solid electrolyte laminate according to claim 1, wherein the lithium salt comprises one or more selected from the group consisting of (CF₃SO₂)₂NLi(lithium bis(trifluoromethanesulphonyl)imide, LiTFSI), (FSO₂)₂NLi (lithium bis(fluorosulfonyl)imide, LiFSI), LiNO₃, LiOH, LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, LiSCN, and LiC(CF₃SO₂)₃.

10. The polymer solid electrolyte laminate according to claim 1, wherein a molar ratio ([Li]/[G]) of lithium ([Li]) of the lithium salt to the cross-linkable functional group ([G]) of the polymer is more than 0.1 and less than 0.5.

11. The polymer solid electrolyte laminate according to claim 1, wherein the solvent comprises water.

12. The polymer solid electrolyte laminate according to claim 1, wherein the polymer solid electrolyte is in the form of a free-standing film or a coating layer.

13. The polymer solid electrolyte laminate according to claim 1, wherein the polymer solid electrolyte further comprises a liquid electrolyte.

14. A method for preparing a polymer solid electrolyte laminate, the method comprising:
(S1) forming a solution by adding a lithium salt to a polymer solution including a polymer containing a cross-linkable functional group and a solvent;
(S2) forming a coating film by applying the solution on a substrate;
(S3) forming a polymer solid electrolyte by freezing and thawing the coating film; and
(S4) laminating a protective layer on at least one surface of the polymer solid electrolyte.

15. The method according to claim 14, wherein the polymer solid electrolyte comprises a cross-linked structure,
the cross-linked structure comprises (a) a cross-linkage between the cross-linkable functional groups, (b) a cross-linkage between the cross-linkable functional group and solvent, and (c) a bond between the cross-linkable functional group and the lithium salt,
wherein (a) the cross-linkage between the cross-linkable functional groups comprises a hydrogen bond,
(b) the cross-linkage between the cross-linkable functional group and the solvent comprises a hydrogen bond, and
(c) the bond between the cross-linkable functional group and the lithium salt comprises a Lewis acid-base interaction.

16. The method according to claim 14, wherein the freezing is performed at −30° C. to −10° C.

17. The method according to claim 14, wherein the thawing is performed at 15° C. to 35° C.

18. An all-solid-state battery comprising the polymer solid electrolyte of claim 1.
